(19) United States
(12) Patent Application Publication
(10) Pub. No.: US 2021/0012203 A1
(43) Pub. Date: Jan. 14, 2021

(54) ADAPTIVE FILTER REPLACEMENT IN CONVOLUTIONAL NEURAL NETWORKS

(71) Applicant: Advanced Micro Devices, Inc., Santa Clara, CA (US)

(72) Inventors: Abhinav Vishnu, Austin, TX (US); Prakash Sathyanath Raghavendra, Bangalore (IN); Tamer M. Elsharnouby, Santa Clara, CA (US); Rachida Kebichi, Boxborough, MA (US); Walid Ali, Santa Clara, CA (US); Jonathan Charles Gallmeier, Austin, TX (US)

(73) Assignee: Advanced Micro Devices, Inc., Santa Clara, CA (US)

(21) Appl. No.: 16/508,277

(22) Filed: Jul. 10, 2019

(51) Int. Cl. G06N 3/08

(52) U.S. Cl. CPC G06N 3/084

(57) ABSTRACT

Systems, methods, and devices for increasing inference speed of a trained convolutional neural network (CNN). A first computation speed of first filters having a first filter size in a layer of the CNN is determined, and a second computation speed of second filters having a second filter size in the layer of the CNN is determined. The size of at least one of the first filters is changed to the second filter size if the second computation speed is faster than the first computation speed. In some implementations the CNN is retrained, after changing the size of at least one of the first filters to the second filter size, to generate a retrained CNN. The size of a fewer number of the first filters is changed to the second filter size if a key performance indicator loss of the retrained CNN exceeds a threshold.

### BACKGROUND

An artificial neural network (ANN) is a computing device or system inspired by the way biological nervous systems, such as brains, process information. An ANN includes an interconnected group of nodes (i.e., artificial neurons). The nodes are interconnected by links, sometimes referred to as synapses in this context. Each node can receive input data, perform operations on the data, and pass the results on to other nodes. The output of a node can be referred to as its activation, or node value. Each of the links is associated with a weight. The ANN can be trained by inputting a training data set, having a known correct output, to generate an output inference. The output inference can be compared to the known correct input, and the difference, if any, can be used to adjust the weights. This procedure can be performed iteratively to converge on an optimized weighting for the ANN based on that training data set. After the ANN is trained, it can draw inferences based on input data, within a degree of confidence that is based upon the training of the ANN.

Convolutional neural networks (CNN) are a class of ANN, typically applied to image analysis, and which typically include convolution and pooling functions, among others.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a schematic diagram illustrating an example ANN;

FIG. 4 is a flow chart which illustrates an example process for replacing filters in a CNN;

FIG. 5 is a flow chart which illustrates an example process for creating a timing profile;

FIG. 6 is a flow chart which illustrates an example process for scaling filters;

FIG. 7 is a flow chart which illustrates an example process for downscaling filters;

FIG. 8 is a block diagram illustrating example upscaling of a filter;

FIG. 9 is a block diagram illustrating example downscaling of a filter; and

FIG. 10 is a block diagram illustrating downscaling of an example layer of a CNN.

### DETAILED DESCRIPTION

Some implementations provide a method for increasing inference speed of a trained convolutional neural network (CNN). A first computation speed of first filters having a first filter size in a layer of the CNN is determined, a second computation speed of second filters having a second filter size in the layer of the CNN is determined; and the size of at least one of the first filters is changed to the second filter size if the second computation speed is faster than the first computation speed.

In some implementations the CNN is retrained, after changing the size of at least one of the first filters to the second filter size, to generate a retrained CNN, a key performance indicator (KPI) loss of the retrained CNN is determined, and the size of a fewer number of the first filters is changed to the second filter size if the KPI loss exceeds a threshold. In some implementations, the size of a greater number of the first filters is changed to the second filter size if the KPI loss does not exceed the threshold. In some implementations, changing first filters to the second filter size includes upscaling the at least one of the first filters. In some implementations, the upscaling includes padding the at least one of the first filters with zero weights. In some implementations, changing first filters to the second filter size includes downscaling the at least one of the first filters. In some implementations, the downscaling includes max pooling. In some implementations, a norm of each of the first filters is determined, and the first filters are ranked by their norms. A lowest normed filter of the first filters is scaled, and a highest normed filter of the first filters is not scaled. In some implementations, the size of at least one of the first filters is changed to a third filter size if the second computation speed is slower than the first computation speed. In some implementations, the size of at least one of the first filters is changed to the second filter size if the second computation speed is equal to the first computation speed.

Some implementations provide a processor for increasing inference speed of a trained CNN. The processor includes circuitry that determines a first computation speed of first filters having a first filter size in a layer of the CNN, determines a second computation speed of second filters having a second filter size in the layer of the CNN, and changes the size of at least one of the first filters to the second filter size if the second computation speed is faster than the first computation speed.

In some implementations, the processor includes circuitry to retrain the CNN, after changing the size of at least one of the first filters to the second filter size, to generate a retrained CNN, to determine a KPI loss of the retrained CNN, and to change the size of a fewer number of the first filters to the second filter size if the KPI loss exceeds a threshold. In some implementations, the processor includes circuitry that changes the size of a greater number of the first filters to the second filter size if the KPI loss does not exceed the threshold. In some implementations, changing first filters to the second filter size includes upscaling the at least one of the first filters. In some implementations, upscaling includes padding the first filters with zero weights. In some implementations, changing first filters to the second filter size includes downscaling the first filters. In some implementations, downscaling includes max pooling. In some implementations, the processor includes circuitry to determine a norm of each of the first filters, to rank the first filters by their norms, to scale a lowest normed filter of the first filters, and not to scale a highest normed filter of the first filters. In some implementations, the processor includes circuitry that changes the size of at least one of the first filters to a third filter size if the second computation speed is slower than the first computation speed. In some implementations, the processor includes circuitry that changes the size of at least one of the first filters to the second filter size if the second computation speed is equal to the first computation speed.

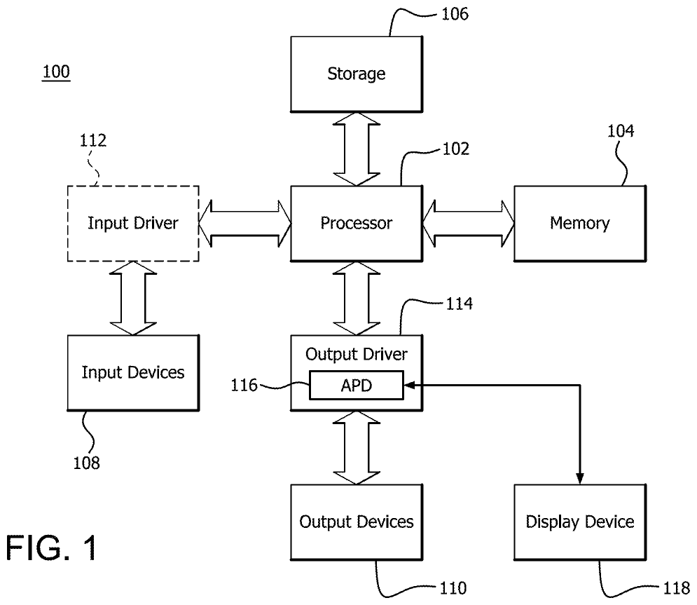

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and to provide graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

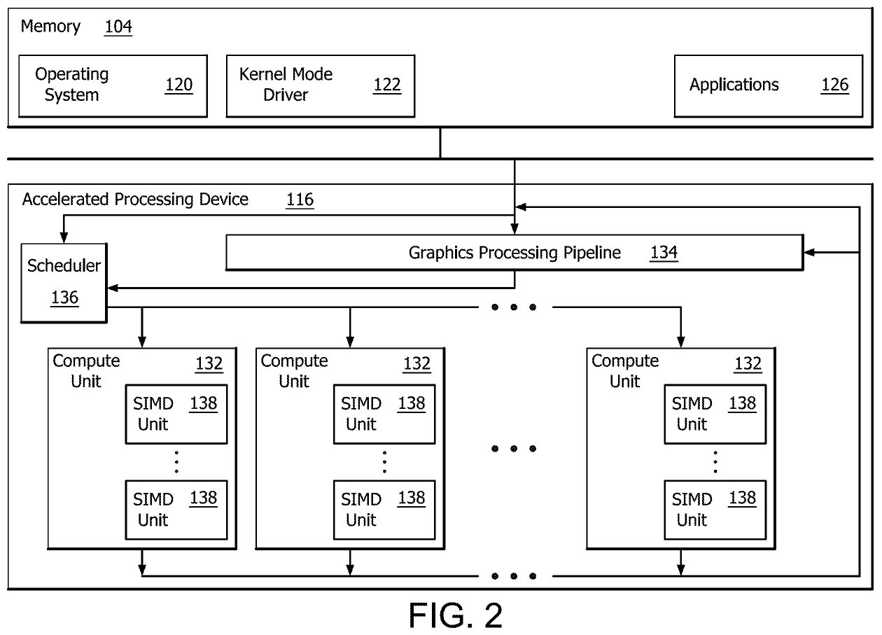

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some cases, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

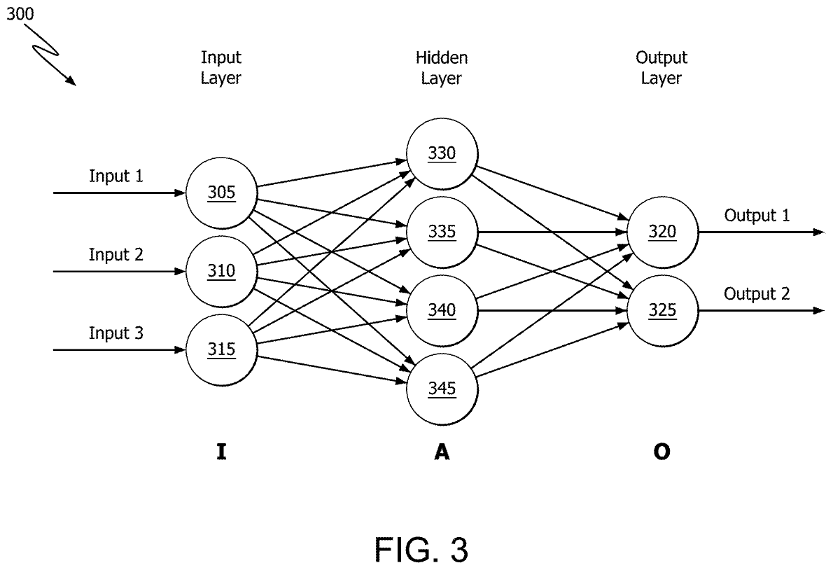

FIG. 3 is a schematic diagram illustrating an example ANN 300. ANN 300 includes a plurality of nodes such as input nodes 305, 310, 315; output nodes 320, 325; and hidden nodes 330, 335, 340, 345. ANN 300 is described generally as an ANN, however this description also broadly illustrates a CNN.

Example ANN 300 is organized into layers, including an input layer I, an output layer O, and a hidden (i.e., not input or output) layer A. Input layer I includes input nodes 305, 310, 315. Output layer O includes output nodes 320, 325. Hidden layer A includes hidden nodes 330, 335, 340, 345. In this context, describing a node or layer as hidden means that it is both input to and output from only by other nodes of the ANN, unlike input nodes and output nodes, which have a regular input or output interface with components outside of the ANN. A layer which outputs to or inputs from another layer can be described as logically adjacent to that layer. For example, in ANN 300, hidden layer A can be described as logically adjacent to input layer I and to output layer O. Logical adjacency in this context neither requires nor excludes physical adjacency.

The input, output, and hidden layers are interconnected by various links as shown in FIG. 3. In the example of ANN 300 each node shares a link with each node in its logically adjacent layers (i.e., is fully connected). The topology of ANN 300 is only one example, and it is noted that an ANN can be arranged in any suitable topology. For example, an ANN may instead include a different number of hidden layers, different numbers of input and/or output nodes, and/or different numbers and/or arrangements of links. ANN 300 is shown as having only one hidden layer, however the techniques described herein can also be applied to deep neural networks (i.e., having more than one hidden layer). It is noted that in other ANNs, each node need not share a link with each node in its logically adjacent layers (i.e., may not be fully connected).

Each of the hidden nodes of ANN 300 receives data from one or more preceding (i.e., closer to the input layer) nodes in a logically adjacent layer via a link, and outputs data to one or more succeeding (i.e., closer to the output layer) nodes in a logically adjacent layer via a link. For example, hidden node 330 inputs data from each of input nodes 305, 310, 315 via corresponding links, and outputs data to each of output nodes 320, 325 via corresponding links.

Each node processes its input data according to a function, which can be referred to as an activation function of the node. Each of the links is associated with a weight by which the data passing over that link is weighted (e.g., multiplied) before it is input to the activation function. For example, the data input to hidden node 330 is weighted according to the link weight of each corresponding input link from input nodes 305, 310, 315. Thus, if the link weight of the link from input node 305 is other than 1, the data will be modified based on the link weight before it is processed by the activation function of hidden node 330. If the link weight of the link from input node 310 differs from the link weight of the link from input node 305, the data from each of the input nodes will be weighted differently before it is processed by the activation function of hidden node 320. Similarly, the data output from hidden node 330 to each of output nodes 320, 325 of output layer O is weighted according to each corresponding output link. In some implementations (e.g., image processing) the link weight of each input link to a node is expressed as a vector or matrix of weights. For example, in some implementations the input weights for a node that inputs a square grid of 9 pixels is expressed as a 3×3 matrix. In some implementations, the vector or matrix of weights is referred to as a filter (e.g., a 3×3 filter, 5×5 filter, 7×7 filter, etc.). In some examples, filters are implemented as an instance of a kernel executing on a processor (e.g., a GPU). For example, if hidden nodes 330 and 335 each include a 5×5 filter, each of the filters is an instance of the same 5×5 filter kernel. Similarly, if hidden nodes 340 and 345 each include a 7×7 filter, each of the filters is an instance of the same 7×7 filter kernel.

Hidden node 330 processes the data input from input nodes 305, 310, 315, as weighted by the corresponding link weights or filters, according to its activation function to generate output data. This output data from hidden node 330 is in turn input by output nodes 320, 325 of output layer O, as weighted by the link weights or filters associated with the corresponding links. Based on the activation functions of each of the nodes and the link weights or filters of each of the links in ANN 300, an output is generated at output nodes 320, 325 based on data input to input nodes 305, 310, 315.

The nodes of ANN 300 can be implemented on any suitable processing device or devices, such as APD 116 as shown and described with respect to FIGS. 1 and 2. For example, all layers of ANN 300 can be implemented on a single compute unit 132 of APD 116. Alternatively, each layer can be implemented on a different compute unit 132 of APD 116, or subsets of layers of ANN 300 can be implemented on different compute units 132 of APD 116. Compute units 132 are shown as incorporating various SIMD units 138, however it is noted that other kinds of compute units, e.g., which do not incorporate SIMD units, may be used in other implementations.

ANN 300 can be trained in any suitable way. In this example, ANN 300 is trained to generate a suitably accurate inference by inputting a training data set to the input layer I, and comparing the resulting output at the output layer O with a known correct output for the training data set. The difference between the output generated by ANN 300 and the known correct output is quantified or otherwise characterized (e.g., using a cost function), and the difference is known as the training loss. This difference is used to adjust the ANN. Such adjustments include altering link weights of one or more of the links. It is noted that in other examples, other kinds of adjustments may be performed, such as altering activation functions of one or more of the nodes. The training process iterates until the difference, i.e., the training loss is acceptably reduced (e.g., below a threshold). Each iteration of such training can be referred to as an epoch. This particular type of training can be referred to as back propagation training. Back propagation training is only one example way in which ANN 300 can be trained; any suitable training techniques may be used to train ANN 300.

The threshold below which the accuracy of inference would be unacceptable is a key performance indicator (KPI) which can be used to train the ANN. In some implementations however, the ANN can be trained based on additional KPIs, such as speed, and power consumption. For example, in some applications, it may be desired to train an ANN to meet both accuracy and speed KPIs. In such applications, a model of the ANN that meets the accuracy KPI (i.e., generates inferences accurately enough) but not the speed KPI (i.e., does not generate inferences fast enough) may be retrained to increase inference speed even if this reduces accuracy, if the accuracy of the retrained ANN still meets the accuracy KPI.

Various factors contribute to the amount of time required for training ANN 300, or performing inferences using ANN 300 (or any ANN). Such factors include the time needed to perform operations on data (e.g., by activation functions or filters in each node), and time needed to transfer data, weights, or other information over the communications channels associated with the ANN (e.g., via links between nodes). For example, the ANN is implemented using a GPU, and filters of the ANN are implemented as instances of kernels executing on the GPU, then the speed of the ANN will depend partly on the execution speed of the kernels. If the speed of the filters is increased, then typically the overall inference speed of the ANN will be increased. Accordingly, in some implementations, slower filters are replaced with faster filters in a manner which avoids unacceptable KPI degradation in the ANN.

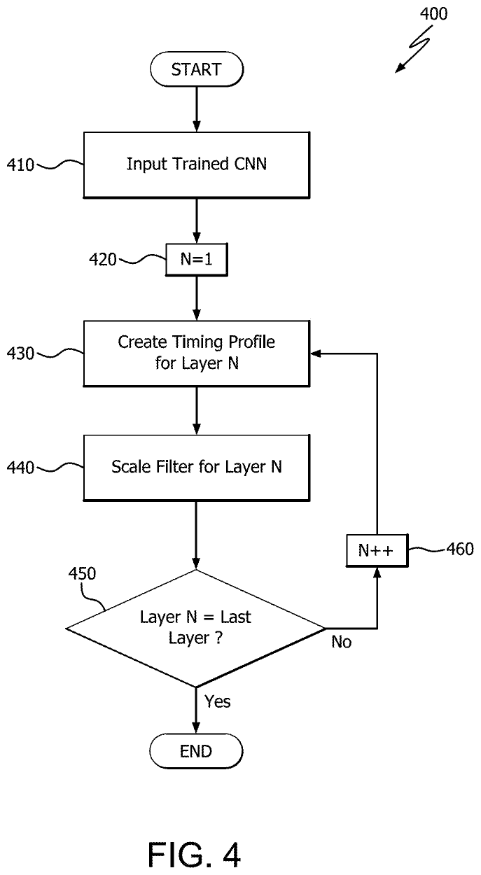

FIG. 4 is a flow chart which illustrates an example process 400 for replacing filters in a CNN. Process 400 is usable for optimization of a trained CNN, (e.g., for implementation on a particular target hardware device, such as a GPU) and is implementable on any suitable computing device, such as device 100 as shown and described with respect to FIGS. 1 and 2. For example, the CNN and optimization hardware may be implemented using any suitable computing device capable of implementing and altering a CNN, and performing inference calculations using the CNN, typically including processing circuitry and non-transitory computer readable memory in communication with the processing circuitry.

In step 410, process 400 inputs a trained CNN (e.g., by scheduling a GPU kernel or kernels on a GPU, where the kernel(s) describes the CNN. In some implementations, the CNN is described in using a high level framework, e.g., TensorFlow or PyTorch), and in step 420, an iteration counter is set to N=1. It is noted that the convention of setting a counter in this way is used for convenience and ease of description only, and that any suitable mechanism for progressing through each layer of the CNN is usable in other implementations. In this example, N=1 refers to the layer closest to the input of the CNN, and increasing values of N refer to layers progressively closer to the output of the CNN.

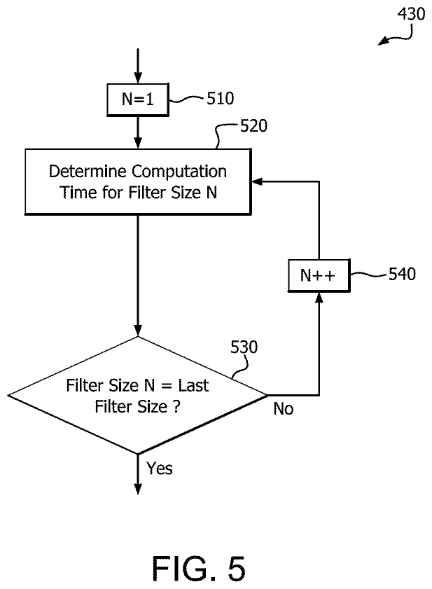

In step 430, the computation speed of each of the sizes of filters in layer N of the CNN is determined. In this example, a training set is run on the CNN as installed on the target hardware (or on a simulation thereof) and a timing profile of each of the sizes of filters in layer N is created. The timing profile reflects the speed (or relative speed) of each of the sizes of filters in layer N. For example, if layer N includes 1×1 filters, 3×3 filters, 5×5 filters, and 7×7 filters, the timing profile reflects the computation speed of each filter, or the relative speed of each filter to the others. In some implementations, the performance (i.e., computation speeds, or relative computation speeds) of each filter is computed using timers and software tools, such as HCC_PROFILE. In other implementations, the computation speeds (or relative computation speeds) of different filter sizes are determined in any suitable way. An example of further detail of step 430 is shown and described with respect to FIG. 5.

In step 440, filters in layer N are scaled based on the timing profile created in step 430 to increase the computational speed of the CNN on the target hardware. For example, if 7×7 filters are faster than 5×5 filters, some or all of the 5×5 filters are “upscaled” and instantiated as 7×7 filters. In this example, the number of a particular size of filter that are upscaled is equal to, or based on, the maximum number of slower filters that can be upscaled to faster filters without unacceptable degradation in KPI of the CNN. In some implementations, all filters that are slower than a larger filter are upscaled, e.g., because the upscaled filter is semantically equivalent to the original filter and will not result in accuracy loss. It is noted that in some implementations, upscaling increases power consumption per filter. However, in some such implementations, the overall time to solution decreases, decreasing overall energy consumption.

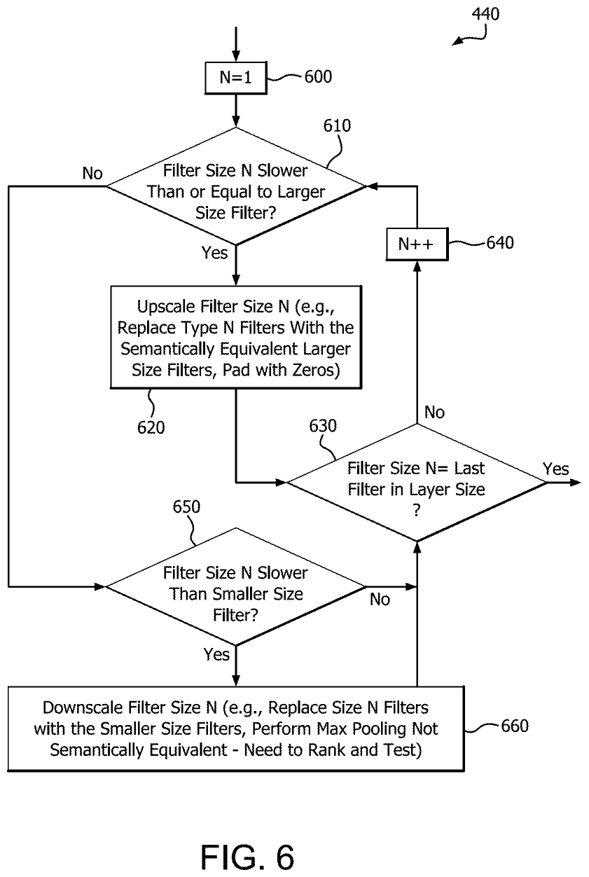

On the other hand, if the 5×5 filters are faster than the 7×7 filters, some or all of the 7×7 filters are “downscaled” and instantiated as 5×5 filters, if and to the extent that this is possible to do without unacceptable degradation in KPI of the CNN. In this example, the number of a particular size of filter that are downscaled is equal to, or based on, the maximum number of slower filters that can be downscaled to faster filters without unacceptable degradation in KPI of the CNN. An example of further detail of step 440 is shown and described with respect to FIG. 6.

In step 450, if layer N is not the last layer in the CNN, the iteration counter is incremented in step 460, and the process repeats from step 430 for the next layer. If layer N is the last layer, process 400 ends, and outputs the trained CNN. It is noted that completing scaling of a layer before beginning scaling the next (i.e., closer to the output) layer converges more quickly in some cases, e.g., because changes in layers closer to the input have a greater effect on the output of the CNN. Accordingly, some implementations stop before scaling all layers (e.g., when a desired optimization target, such as a target speed increase, has been achieved, etc.)

FIG. 5 is a flow chart which illustrates an example process for creating a timing profile of a layer of a CNN, carrying out step 430 as shown and described with respect to FIG. 4.

In step 510, an iteration counter is set to N=1. It is noted that the convention of setting a counter in this way is used for convenience and ease of description only, and that any suitable mechanism for progressing through each filter size in the layer is usable in other implementations. In this example, N=1 refers to the smallest filter size (e.g., 1×1) in the layer, and increasing values of N refer to progressively larger filter sizes (e.g., 3×3, 5×5, etc.). In some implementations, beginning with the smallest filter size and progressing through each progressively larger filter size has the advantage of not requiring retraining of the CNN (e.g., because adding zeros to the smaller filter to create a larger filter by effectively adding a border of zeros does not affect the output of the computations in the filter, such as fused-multiply-add operations). In other implementations, any suitable order of progression through the filter sizes is used.

In step 520, the computation speed of the filter size corresponding to N=1 is calculated. In some implementations, the computation speed is added to a timing profile characterizing the computation speed of all filter sizes in the layer. For example, if layer N includes 1×1 filters, 3×3 filters, and 5×5 filters, the timing profile reflects which filter size is faster. In other implementations, the relative computation speeds of different filter sizes are determined in any suitable way.

In step 530, if filter size N is not the largest filter size in the layer, the iteration counter is incremented in step 540, and the process repeats from step 520 for the next layer. If layer N is the largest filter size, step 430 is complete and outputs the timing information (e.g., timing profile) to the scaling operation (e.g., step 440 as shown and described with respect to FIG. 4. In other implementations, one or more filter sizes are omitted from the process.

FIG. 6 is a flow chart which illustrates an example process for scaling filters in a layer of a CNN, carrying out step 440 as shown and described with respect to FIG. 4.

In step 600, an iteration counter is set to N=1. It is noted that the convention of setting a counter in this way is used for convenience and ease of description only, and that any suitable mechanism for progressing through each filter size in the layer is usable in other implementations. In this example, N=1 refers to the smallest filter size (e.g., 1×1) in the layer, and increasing values of N refer to progressively larger filter sizes (e.g., 3×3, 5×5, etc.). In some implementations, beginning with the smallest filter size and progressing through each progressively larger filter size has the advantage of not requiring retraining of the CNN (e.g., because adding zeros to the smaller filter to create a larger filter by effectively adding a border of zeros does not affect the output of the computations in the filter, such as fused-multiply-add operations). In other implementations, any suitable order of progression through the filter sizes is used.

On a condition 610 that filter size N is slower than or equal in speed to a larger sized filter, filters of size N are upscaled in step 620. It is noted that in this example, filters of size N that are equal in speed are upscaled to improve kernel homogenization. In some other implementations, filters of size N that are equal in speed are not upscaled. In this example, a filter of size N can be upscaled by padding the border of the filter (e.g., with zeros). For example, the border of a 3×3 square filter can be padded with zeros to yield a semantically equivalent 5×5 square filter. Because the filters are semantically equivalent (i.e., the output of the filter is the same), upscaling does not impact the accuracy (e.g., pixel resolution in the case of image analysis) of the CNN. Accordingly, in some implementations, all such filters are upscaled. In some implementations, the upscaled filter is semantically equivalent with the original filter because the filter operation is a fused multiply add operation, where multiplication with zeros (i.e., the padding) does not alter the output. In this example, if filter size N is equal in speed to the larger sized filter, it is upscaled to homogenize the filters within the layer. In some implementations this has the advantage of consolidating the filters to a fewer number of filter sizes. In some implementations, consolidating the filters (fully or partially) to a fewer number of filter sizes (and accordingly, a fewer number of filter kernels) in this way has the advantage of increasing efficiency of the hardware through kernel fusion. In other implementations, other approaches can be taken to homogenize the filters within a layer. In other implementations filter size N is not upscaled where it is equal in speed.

On a condition 630 that filter size N is the last filter size in the layer, scaling is complete for the layer, and in this example the flow returns to condition 450 as shown and described with respect to FIG. 4. Otherwise, if filter size N is not the largest filter size in the layer, the iteration counter is incremented in step 640, and the process repeats from step 610 for the next filter size. On condition 610 that the filter size N is not slower than or equal in speed to a larger sized filter, the flow proceeds to condition 650.

On a condition 650 that filter size N is slower than a smaller sized filter, filters of size N are downscaled to the smaller filter size in step 660 if it is possible to do so without causing the CNN to violate one or more KPIs. In this example, downscaling is done to the next available smaller sized filter. In some implementations, this has the advantage of a greater chance of maintaining accuracy of inference than downscaling to a filter smaller than the next available smaller sized filter. In other implementations, downscaling can be done to a filter smaller than the next available smaller sized filter (e.g., using a straight approximation, such as scaling from a 7×7 filter to a 3×3 filter without intermediate scaling). In some such implementations, less retraining is required to converge on a desired filter size, potentially with a lesser chance of maintaining accuracy of inference.

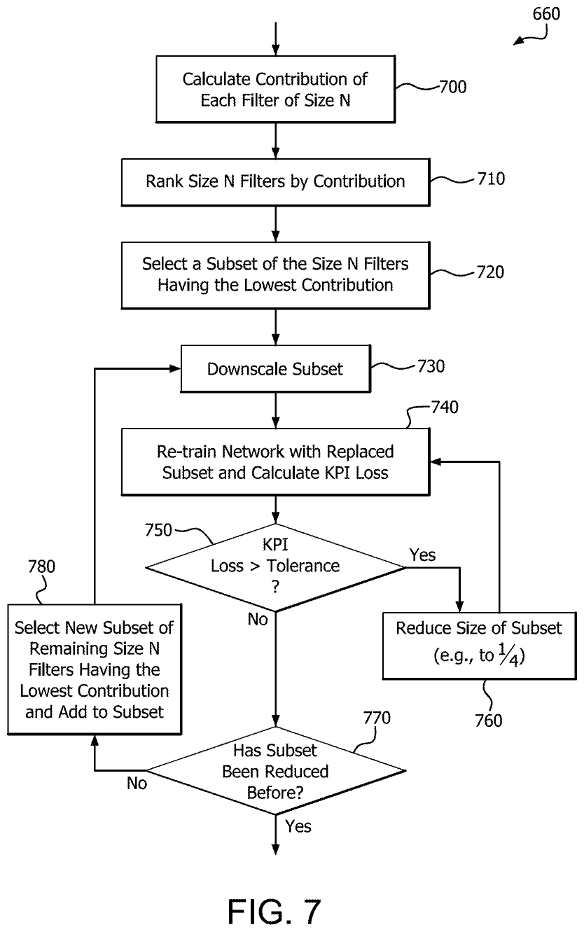

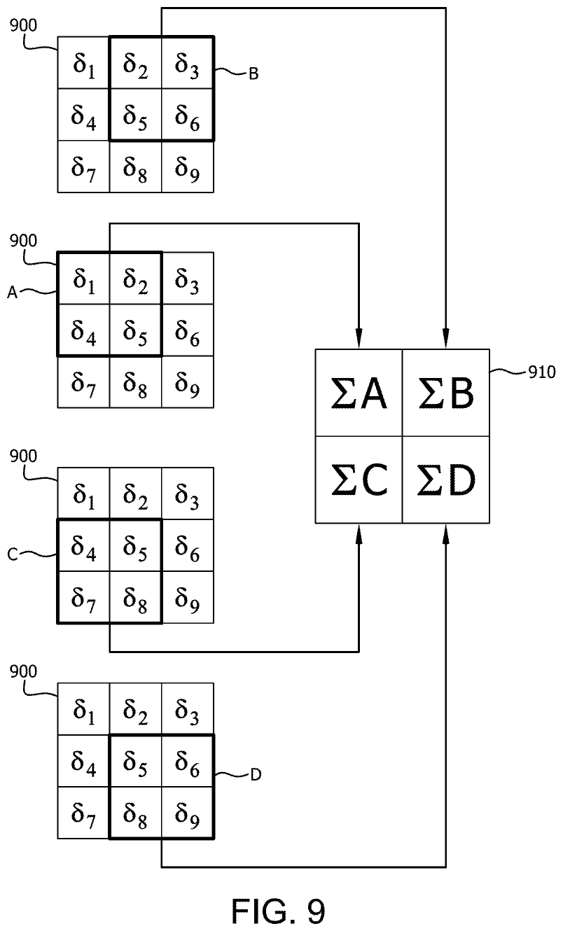

In this example, filter downscaling is done using max pooling, however in other implementations any suitable downscaling process is used. In other implementations, average pooling, random pooling, or any other suitable operation is used. Max pooling, in this context, is a technique for down-sampling an array of data by dividing the array into pools and selecting the maximum value of the pool to represent a single element in the down-sampled pool. An example of max pooling is shown in FIG. 9, described later herein. Typically, replacing a filter with a smaller sized filter does not yield a semantically equivalent filter. For example, if max pooling is applied to a 5×5 filter to yield a 3×3 filter, the resulting 3×3 filter will be less accurate (e.g., have a lower pixel resolution in the case of image analysis). Accordingly, in some cases only a subset, if any, of the filters of filter size N will be scaled. In this example, the number of filters of filter size N that are downscaled is equal to, or based on, the maximum number of filters of filter size N that can be downscaled to the faster filter size without unacceptable degradation in KPI of the CNN. An example of further detail of step 660 is shown and described with respect to FIG. 7. After downscaling, the flow returns to condition 630. On condition 660 that the filter size N is not slower than or equal in speed to a smaller sized filter, the flow proceeds to condition 630 without downscaling.

FIG. 7 is a flow chart which illustrates an example process for downscaling filters in a layer of a CNN, carrying out step 660 as shown and described with respect to FIG. 6.

In step 700, the contribution of each filter of size N in the layer is calculated. The contribution of a filter represents the sum of the absolute values of the weights of the filter. In this example, the contribution of a filter is calculated as an L1 norm of the filter. For example, the L1 norm of a 3×3 filter is the sum of each of the nine elements of the 3×3 matrix of weights representing the filter. Other implementations calculate the contribution of a filter in any suitable manner (e.g., L2 norm, i.e., the square root of the sum of the squares of the vector values; L3 norm, i.e., the cube root of the sum of the cubes of the vector values; L-infinity norm, etc.).

In step 710, the filters of filter size N in the layer are ranked in order of their contribution, as calculated in step 700. In step 720, a subset of the filters of filter size N in the layer is selected. In this example, half of the filters of filter size N, having the lowest contribution, is selected as the subset. In some cases, selecting filters having less impact on the output of the layer has the advantage of facilitating downscaling of filters that have the least effect on accuracy of the CNN.

In step 730, the subset is downscaled to the faster filter size, e.g., by max pooling. In step 740, the CNN is retrained with the replaced filters, and a KPI, or KPI loss, is calculated. In this example, accuracy of inference of the CNN is a KPI, and the accuracy of inference of the retrained CNN is compared with the accuracy of inference of the original CNN to determine the KPI loss. In other implementations other or additional KPIs (e.g., power consumption, speed, etc.) are used.

On a condition 750 that the KPI loss exceeds a tolerance, the size of the subset is reduced in step 760, and the flow returns to step 740, where the network is retrained based on the reduced subset. In this example, if the change in accuracy is above a desired threshold, the KPI loss is said to exceed the tolerance. It is noted that other implementations use an absolute KPI threshold. For example, in some implementations if the KPI of the retrained network exceeds a threshold tolerance, the size of the subset is reduced, irrespective of the difference in KPI of the originally trained network.

In step 760, the size of the subset is reduced, and the flow returns to step 740. This can have the advantage of facilitating optimization of the number of downscaled filters of size N in the layer through iteration. In this example, the size of the subset is reduced by half (i.e., to ¼ the number of filters of size N in the layer) in step 760. In other implementations, any suitable approach to reducing the number of filters in the subset is used.

On condition 750 that the KPI loss does not exceed the tolerance, and on a condition 770 that the subset has not yet been reduced (i.e., in step 760), the size of the subset is expanded in step 780. In this example, the subset is expanded by adding half of the remaining size N filters having the lowest contribution, and downscaling the expanded subset in step 730. On condition 770 that the subset has already been reduced (i.e., in step 760), the downscaling is complete, and flow returns to step 630 as shown and described with respect to FIG. 6.

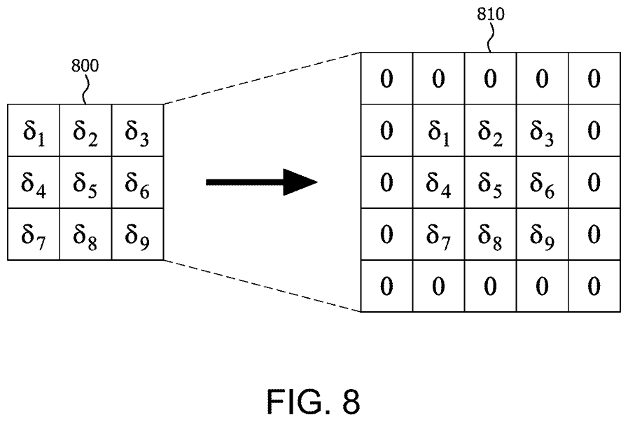

FIG. 8 is a block diagram illustrating example upscaling of a filter. In FIG. 8, filter 800 is a 3×3 filter which includes 9 weights. The value of each of the 9 weights is represented by δ₁₋₉, Each of the weights can have any value (and are not necessarily the same). The 3×3 filter 800 can be upscaled to a semantically equivalent 5×5 filter 810 by padding the outside rows and columns of the matrix of filter 800 with zeros as shown.

FIG. 9 is a block diagram illustrating example downscaling of a filter. In FIG. 9, filter 900 is a 3×3 filter which includes 9 weights. The value of each of the 9 weights is represented by δ₁₋₉, Each of the weights can have any value (and are not necessarily the same). In this example, the 3×3 filter 900 is downscaled to a 2×2 filter 910 by max pooling 3×3 filter 900. The 3×3 filter 900 is illustrated 4 times to more clearly show each of the component pools, A, B, C, and D, used to generate 2×2 filter 910.

In this example, the weights δ₁, δ₂, δ₄, and δ₅, within the upper left quadrant pool A are summed to yield the upper left quadrant weight for 2×2 filter 910 as shown. Similarly, the weights δ₂, δ₃, δ₅, and δ₆, within the upper left quadrant pool B are summed to yield the upper left quadrant weight for 2×2 filter 910; the weights δ₄, δ₅, δ₇, and δ₈, within the lower left quadrant pool C are summed to yield the lower left quadrant weight for 2×2 filter 910; and the weights δ₅, δ₆, δ₈, and δ₉, within the lower right quadrant pool D are summed to yield the lower right quadrant weight for 2×2 filter 910 as shown.

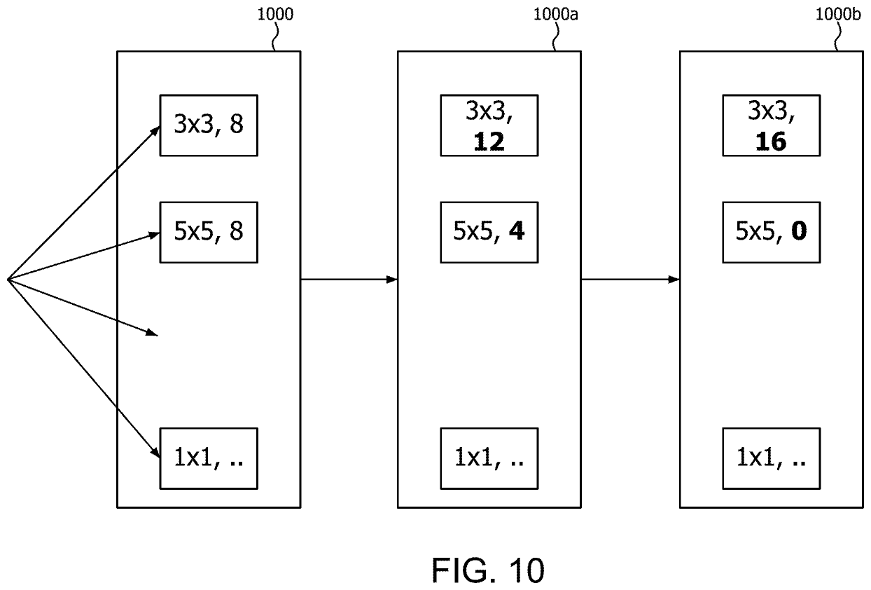

FIG. 10 is a block diagram illustrating downscaling of an example layer 1000 of a CNN (e.g., ANN 300 as shown and described with respect to FIG. 300). Layer 1000 receives several inputs, and applies 8 3×3 filters, 8 5×5 filters, and various 1×1 filters to the inputs. In this example, downscaling is performed as described earlier with respect to FIGS. 4, 5, 6, 7, and 9, however in other implementations, any suitable downscaling is used.

In the example of FIG. 10, timing analysis reveals that 3×3 filters are faster (i.e., require less compute time) than 5×5 filters. Accordingly, in a first step, half of the 5×5 filters are downscaled to 3×3 filters. Example layer 1000a illustrates the resulting 12 3×3 filters, and 4 5×5 filters. The CNN is retrained based on example layer 1000a. In this example, the retrained CNN does not exceed a tolerance for KPI loss. Accordingly, the remaining 5×5 filters are further downscaled. Layer 1000b illustrates the resulting 16 3×3 filters, and 0 remaining 5×5 filters. If the CNN is retrained based on layer 1000b and violates the KPI loss threshold, the most recent downscaling can be repeated with a lesser number of downscaled 5×5 filters. If the retrained CNN does not violate the KPI loss threshold, downscaling can continue based on the next filter size, if any, and so forth. In some implementations, consolidating the filters (fully or partially) to a fewer number of filter sizes (and accordingly, a fewer number of filter kernels) in this way has the advantage of increasing efficiency of the hardware through kernel fusion.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for increasing inference speed of a trained convolutional neural network (CNN), the method comprising:
determining a first computation speed of first filters having a first filter size in a layer of the CNN;
determining a second computation speed of second filters having a second filter size in the layer of the CNN; and
on a condition that the second computation speed is faster than the first computation speed:
changing the size of at least one of the first filters to the second filter size.

2. The method of claim 1, further comprising:
retraining the CNN, after changing the size of at least one of the first filters to the second filter size, to generate a retrained CNN;
determining a key performance indicator (KPI) loss of the retrained CNN; and
changing the size of a fewer number of the first filters to the second filter size if the KPI loss exceeds a threshold.

3. The method of claim 2, further comprising:
changing the size of a greater number of the first filters to the second filter size if the KPI loss does not exceed the threshold.

4. The method of claim 1, wherein changing the at least one of the first filters to the second filter size comprises upscaling the at least one of the first filters to a larger filter size.

5. The method of claim 4, wherein the upscaling comprises padding the at least one of the first filters with zero weights.

6. The method of claim 1, wherein changing the at least one of the first filters to the second filter size comprises downscaling the at least one of the first filters to a smaller filter size.

7. The method of claim 6, wherein the downscaling comprises max pooling, wherein the max pooling comprises selecting the maximum value of each of a plurality of pools of filter weights of the at least one of the first filters to represent a single filter weight in the downscaled filter.

8. The method of claim 1, further comprising:
determining a norm of each of the first filters, and ranking the first filters by their norms;
wherein a lowest normed filter of the first filters is scaled; and
wherein a highest normed filter of the first filters is not scaled.

9. The method of claim 1, further comprising, on a condition that the second computation speed is slower than the first computation speed, changing the size of at least one of the first filters to a third filter size.

10. The method of claim 1, further comprising, on a condition that the second computation speed is equal to the first computation speed, changing the size of at least one of the first filters to the second filter size.

11. A processor configured for increasing inference speed of a trained convolutional neural network (CNN), the processor comprising:
circuitry configured to determine a first computation speed of first filters having a first filter size in a layer of the CNN;
circuitry configured to determine a second computation speed of second filters having a second filter size in the layer of the CNN; and
circuitry configured to, on a condition that the second computation speed is faster than the first computation speed:
change the size of at least one of the first filters to the second filter size.

12. The processor of claim 11, further comprising:
circuitry configured to retrain the CNN, after changing the size of at least one of the first filters to the second filter size, to generate a retrained CNN;
circuitry configured to determine a key performance indicator (KPI) loss of the retrained CNN; and
circuitry configured to change the size of a fewer number of the first filters to the second filter size if the KPI loss exceeds a threshold.

13. The processor of claim 12, further comprising:
circuitry configured to change the size of a greater number of the first filters to the second filter size if the KPI loss does not exceed the threshold.

14. The processor of claim 11, wherein changing the at least one of the first filters to the second filter size comprises upscaling the at least one of the first filters to a larger filter size.

15. The processor of claim 14, wherein the upscaling comprises padding the at least one of the first filters with zero weights.

16. The processor of claim 11, wherein changing the at least one of the first filters to the second filter size comprises downscaling the at least one of the first filters to a smaller filter size.

17. The processor of claim 16, wherein the downscaling comprises max pooling, wherein the max pooling comprises selecting the maximum value of each of a plurality of pools of filter weights of the at least one of the first filters to represent a single filter weight in the downscaled filter.

18. The processor of claim 11, further comprising:
circuitry configured to determine a norm of each of the first filters, and ranking the first filters by their norms;
wherein a lowest normed filter of the first filters is scaled; and
wherein a highest normed filter of the first filters is not scaled.

19. The processor of claim 11, further comprising circuitry configured to, on a condition that the second computation speed is slower than the first computation speed, change the size of at least one of the first filters to a third filter size.

20. The processor of claim 11, further comprising circuitry configured to, on a condition that the second computation speed is equal to the first computation speed, change the size of at least one of the first filters to the second filter size.
